(19) United States
(12) Patent Application Publication
(10) Pub. No.: US 2024/0242120 A1
(43) Pub. Date: Jul. 18, 2024

(54) SYSTEM, METHOD, AND COMPUTER PROGRAM PRODUCT FOR TIME SERIES FORECASTING USING INTEGRABLE MULTIVARIATE PATTERN MATCHING

(71) Applicant: IndicatorLab Inc., Santa Clara, CA (US)

(72) Inventor: Yuhang Wu, Santa Clara, CA (US)

(73) Assignee: IndicatorLab Inc., Santa Clara, CA (US)

(21) Appl. No.: 18/405,587

(22) Filed: Jan. 5, 2024

Related U.S. Application Data
(60) Provisional application No. 63/478,785, filed on Jan. 6, 2023.

(51) Int. Cl. G06N 20/00; G06F 16/2458; G06N 5/022

(52) U.S. Cl. CPC G06N 20/00; G06F 16/2477; G06N 5/022

(57) ABSTRACT

Provided is a system for time series forecasting, including a computer hardware processor; and at least one non-transitory computer-readable storage medium storing instructions that, when executed by the computer hardware processor, causes the processor to perform: obtaining a target time series; obtaining at least one reference time series associated with the target time series; generating a self-similarity vector for the reference time series by determining a similarity between a current time window of the reference time series and one or more subsequences of the reference time series, different from the current time window; based on the self-similarity vector, identifying one or more historic timestamps of the reference time series with similarity values above a threshold similarity value; generating one or more future projections of the target time series based on the identified timestamps; and generating a forecasting of the target time series using a read-out function.

### CROSS-REFERENCE TO RELATED APPLICATIONS

This application claims the benefit of priority under 35 U.S.C. 119(c) to U.S. Provisional Patent Application Ser. No. 63/478,785, filed on Jan. 6, 2023, and titled “SYSTEM, METHOD, AND COMPUTER PROGRAM PRODUCT FOR TIME SERIES FORECASTING USING INTEGRABLE MULTIVARIATE PATTERN MATCHING,” which is incorporated by reference herein in its entirety.

### BACKGROUND

Time series are datasets which include data which has been recorded at set time points. Historic data of time series are often used to predict how the time series will change in the future. Predictions about the time series may be used to inform actions or decisions related to the time series.

### SUMMARY

Some embodiments relate to a system for time series forecasting using a pattern matching-based machine learning model, the system including at least one computer hardware processor, and at least one non-transitory computer-readable storage medium storing processor-executable instructions that, when executed by the at least one computer hardware processor, causes the at least one computer hardware processor to perform a method including obtaining a target time series, obtaining at least one reference time series associated with the target time series, generating a self-similarity vector for the reference time series by determining a similarity between a current time window of the reference time series and one or more subsequences of the reference time series, different from the current time window, based on the self-similarity vector, identifying one or more historic timestamps of the reference time series with similarity values above a threshold similarity value, generating one or more future projections of the target time series based on the identified timestamps, and generating a forecasting of the target time series using a read-out function.

According to some examples, the forecasting of the target time series includes a forecasting of future timestamps of the target time series and a confidence score.

According to some examples, the forecasting of the target time series includes a future distribution of the target time series.

According to some examples, the at least one processor is further programmed to perform determining whether a decision should be taken based on the forecasting of the target time series.

According to some examples, obtaining the at least one reference time series includes transforming the target time series into the at least one reference time series.

According to some examples, obtaining the at least one reference time series includes obtaining the at least one reference time series from a data source external to the system, or obtaining the at least one reference time series from storage of the system.

According to some examples, the at least one reference time series includes a plurality of reference time series, generating the self-similarity vector includes generating a respective plurality of self-similarity vectors, and wherein the at least one computer hardware processor is further configured to perform assigning respective weights to each of the plurality self-similarity vectors, and integrating the plurality of self-similarity vectors using an integration function, wherein the one or more historic timestamps are determined based on the integrated self-similarity vectors.

According to some examples, the at least one computer hardware processor is further configured to perform training a machine learning model, wherein the training includes determining one or more historic time points from the target time series, and, for each of the one or more historic time points, determining respective relevant time points from the target time series, based on a plurality of parameters, wherein each of the relevant time points occur earlier in the time series than the historic time point, comparing a portion of the target time series following the historic time point to a portion of the target time series following each of the relevant time points, and based on the comparing, updating one or more of the plurality of parameters.

According to some examples, the plurality of parameters includes a subsequence length for generating the self-similarity vector, self-similarity vector weights, and read-out function parameters.

According to some examples, generating the self-similarity vector includes, for each of the one or more subsequences, determining a distance between the current time window and the subsequence, and concatenating the distance into a self-similarity vector.

Some embodiments relate to a method for time series forecasting using a pattern matching-based machine learning model, the method including using at least one computer hardware processor to perform obtaining a target time series, obtaining at least one reference time series associated with the target time series, generating a self-similarity vector for the reference time series by determining a similarity between a current time window of the reference time series and one or more subsequences of the reference time series, different from the current time window, based on the self-similarity vector, identifying one or more historic timestamps of the reference time series with similarity values above a threshold similarity value, generating one or more future projections of the target time series based on the identified timestamps, and generating a forecasting of the target time series using a read-out function.

According to some examples, obtaining the at least one reference time series includes transforming the target time series into the at least one reference time series, obtaining the at least one reference time series from a data source external to a system containing the at least one computer hardware processor, or obtaining the at least one reference time series from storage of the system.

According to some examples, the at least one reference time series includes a plurality of reference time series, generating the self-similarity vector includes generating a respective plurality of self-similarity vectors, and further including assigning respective weights to each of the plurality self-similarity vectors, and integrating the plurality of self-similarity vectors using an integration function, wherein the one or more historic timestamps are determined based on the integrated self-similarity vectors.

According to some examples, the method of further includes training a machine learning model, wherein the training includes determining one or more historic time points from the target time series, and, for each of the one or more historic time points, determining respective relevant time points from the target time series, based on a plurality of parameters, wherein each of the relevant time points occur earlier in the time series than the historic time point, comparing a portion of the target time series following the historic time point to a portion of the target time series following each of the relevant time points, and based on the comparing, updating one or more of the plurality of parameters.

According to some examples, the plurality of parameters includes a subsequence length for generating the self-similarity vector, self-similarity vector weights, and read-out function parameters.

According to some examples, generating the self-similarity vector includes, for each of the one or more subsequences, determining a distance between the current time window and the subsequence, and concatenating the distance into a self-similarity vector.

Some embodiments relate to at least one non-transitory computer-readable storage medium storing processor-executable instructions that, when executed by at least one computer hardware processor, causes the at least one computer hardware processor to perform a method including obtaining a target time series, obtaining at least one reference time series associated with the target time series, generating a self-similarity vector for the reference time series by determining a similarity between a current time window of the reference time series and one or more subsequences of the reference time series, different from the current time window, based on the self-similarity vector, identifying one or more historic timestamps of the reference time series with similarity values above a threshold similarity value, generating one or more future projections of the target time series based on the identified timestamps, and generating a forecasting of the target time series using a read-out function.

According to some examples, obtaining the at least one reference time series includes transforming the target time series into the at least one reference time series, obtaining the at least one reference time series from a data source external to a system containing the at least one computer hardware processor, or obtaining the at least one reference time series from storage of the system.

According to some examples, the at least one reference time series includes a plurality of reference time series, generating the self-similarity vector includes generating a respective plurality of self-similarity vectors, and wherein the method further includes assigning respective weights to each of the plurality self-similarity vectors, and integrating the plurality of self-similarity vectors using an integration function, wherein the one or more historic timestamps are determined based on the integrated self-similarity vectors.

According to some examples, the method further includes training a machine learning model, wherein the training includes determining one or more historic time points from the target time series, and, for each of the one or more historic time points, determining respective relevant time points from the target time series, based on a plurality of parameters, wherein each of the relevant time points occur earlier in the time series than the historic time point, comparing a portion of the target time series following the historic time point to a portion of the target time series following each of the relevant time points, and based on the comparing, updating one or more of the plurality of parameters, wherein the plurality of parameters includes a subsequence length for generating the self-similarity vector, self-similarity vector weights, and read-out function parameters.

### BRIEF DESCRIPTION OF FIGURES

Various aspects of at least one embodiment are discussed herein with reference to the accompanying figures, which are not intended to be drawn to scale. The figures are included to provide illustration and a further understanding of the various aspects and embodiments and are incorporated in and constitute a part of this specification but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence is intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1A is a diagram of an example system for time-series forecasting, according to some aspects of the technology described herein.

FIG. 1B is a flow chart for an example process for performing time-series forecasting using a system, according to some aspects of the technology described herein.

FIG. 2 is a flow chart of an example process for performing time series forecasting, according to some aspects of the technology described herein.

FIG. 3A is a flowchart of an example process for learning the parameters used in integrable multivariate pattern matching, according to some aspects of the technology described herein.

FIG. 3B is a flowchart of an example process for training a machine learning model for time series forecasting parameters, according to some aspects of the technology described herein.

FIG. 4 is a diagram of an example time series, according to some aspects of the technology described herein.

FIG. 5 is a diagram of example reference time series, according to some aspects of the technology described herein.

FIG. 6 is a diagram of an example integrated self-similarity vector, according to some aspects of the technology described herein.

FIG. 7 is a diagram of an example process for determining timestamps from a self-similarity vector, according to some aspects of the technology described herein.

FIG. 8 is a diagram of example patterns of two reference time series, according to some aspects of the technology described herein.

FIG. 9 is a diagram of example parameters of a read-out function, according to some aspects of the technology described herein.

FIG. 10 is a diagram of an example time series forecasting, according to some aspects of the technology described herein.

FIG. 11A is a diagram of an example user interface dashboard, according to some aspects of the technology described herein.

FIG. 11B is a diagram of an example user interface model, according to some aspects of the technology described herein.

FIG. 12 is a diagram of an example computer system, according to some aspects of the technology described herein.

### DETAILED DESCRIPTION

The present disclosure relates generally to systems, devices, products, apparatus, and methods for time series forecasting, and in one embodiment or aspect, to a system, product, and method for time-series forecasting using a multivariate pattern matching and integration algorithm.

A time series forecasting problem is to determine a time series future based on past data. In some instances, each time-dependent variable may depend not only on that time-dependent variable's past values but also on other time-dependent variables in other time series. These time series may jointly provide better prediction capability to forecast future values of the time-dependent variable.

Most time series have different scales, lengths, and data distribution, it is hard to directly integrate time series with a static model for forecasting without mapping them into a common space.

Traditional methods for forecasting time series include statistical methods such as Monte Carlo simulations. These methods are often based on forecasting using random variables and fixed time windows of a particular time series, which results in much of the data used for forecasting not being representative of the current state of the time series. Additional methods, including regression-based approaches, such as linear regression and neural networks for time series forecasting, suffer from similar problems, as the data used in training and predictions is a fixed time window. These methods involve fitting linear parameters to historical data and therefore require a fixed time window of data. Fixed time windows cannot account for whether the data included is relevant to the current state of the time series. Therefore, the forecastings generated using traditional methods with fixed time windows are often inaccurate and inapplicable to the time series and suffer from regime change and non-linear transformations.

The inventors have recognized and appreciated that conventional techniques for forecasting time series are unable to meet the needs of users and often provide inaccurate predictions. Such inaccurate predictions are limited in their applicability to actions or decisions which may be taken related to the time series.

To solve the above-described technical problems and/or other technical problems, the inventors have recognized and appreciated that time series forecasting using multivariate pattern matching may provide improved accuracy and applicability of time series forecasting predictions.

In multivariate-based time series forecasting, each time series forecasting capability may change in a time or event-dependent manner, so a commonly used static model may hard to give an accurate answer when one or multiple time series lost its capability of forecasting.

Most of the existing models like deep neural networks cannot provide an easy explanation of how the forecasting is made.

A time-series forecasting model should work consistently well to be considered reliable, however, determining the consistency for a forecasting model without knowing the ground-truth data remains an open problem.

Accordingly, systems, devices, products, apparatus, and/or methods for time series forecasting using multivariate pattern matching are disclosed that overcome some or all the deficiencies of the prior art.

In at least some of the embodiments described herein, a time series is a dataset containing values of a variable over a time period and the time at which each value occurred. In some examples, a time series may include values of a single variable. In some examples, a time series may include data of multiple variables, for example two variables, three variables, four variables, five variables, between one and ten variables or greater than ten variables. In some examples, time series may include values of the variable at set time intervals. For example, a time series may contain a value for a variable at sub minute intervals, one to ten minute intervals, ten minute to one hour intervals, one to six hour intervals, six to twelve hour intervals, twelve hour to one day intervals, or time intervals greater than one day. In some examples, the time intervals between values of the variable are regular. In some examples, the time intervals between values of the variable are not regular.

In some examples, a variable of a time series may be any variable which changes over time. For example, a variable may include environmental information such as weather and temperature; financial information such as stock price, asset price, commodity price, asset risk, portfolio value, or portfolio risk; physical information such as operating parameters of factories or machinery; commercial information such as productivity, demand, customers, visitors, or pricing; among other information which varies over time.

In some examples, the risk model derived a time series forecasting system can be used for hedge funds, retirement planning for registered investment advisors, financial planning for certified financial planners, and/or market making for exchanges. In some examples a time series forecasting system may be used for private markets, alternative markets, and/or secondary market to project the future of the return of an illiquid asset such as seed round startups, the price of wines and etc. In some examples, a time series forecasting model may be used for market making in spot and future markets, as well as prediction market to understand the trend and risk of the market.

In some examples, one or more reference time series may be used in the forecasting for a particular time series. In some examples, a reference time series may be a time series related to the particular time series being forecasted. For example, if a temperature time series for a location is being forecasted, a reference time series related to wind direction for that location may be used in the forecasting. In another example, if a stock price is to be forecasted, a reference time series related to sentiment analysis of the stock may be used in the forecasting. In some examples, the time period of a reference time series may be the same as that of the target time series. In some examples, the time period of a reference time series may overlap with at least a portion of the target time series.

In some examples, a time series with limited data may be forecasted. In some examples, a time series with limited data may include data recorded over a short time period, for example a time period less than one day, less than one week, less than one month, less than six months, less than one year, less than two years, less than five years, or less than ten years. In some examples, a time series with limited data may include few data points, relative to the forecasting to be performed.

In some examples, when a time series with limited data is to be forecasted, the time series may be combined with one or more other time series to form a simulated time series. In some examples, a time series with limited data may be combined with one or more related time series to form a simulated time series. For example, if the visitors for a particular restaurant is to be forecasted, and the time series for the restaurant visitors is limited, time series for different restaurants may be combined with the time series for the particular restaurant to form the simulated time series.

In some examples, one or more machine learning models may be used in the time series forecasting. In some examples, the machine learning models may be a neural network, statistical model or other suitable machine learning model. In some examples, a machine learning model may be used to determine one or more parameters used in time series forecasting, for example subsequence length, transformation parameters, vector weights, and/or read-out function parameters. In some examples, a machine learning model may be used in determining a reference time series. In some examples, a machine learning model may be used in determining the distance or similarity between subsequences of a time series during a time series forecasting.

In some examples, time series forecasting may involve identifying one or more key timestamps from a time series. In some examples, the key timestamps are historic timestamps from the time series, in which the behavior of the variable is similar to the behavior of the variable at the most recent time point of the time series. In some examples, a single key timestamp is identified. In some examples, multiple key timestamps are identified, for example, two key timestamps, three key timestamps, four key timestamps, five key timestamps, five to ten key timestamps, or greater than ten key timestamps.

In some examples, time series forecasting may involve analyzing identified key timestamps with a read-out function. In some examples, a read-out function may analyze the behavior before and after the identified key timestamp(s) to generate a prediction and/or confidence score for the time series. In some examples, the read-out function may determine the prediction by averaging the time series following the key timestamp(s). In some examples, the read-out function may determine the prediction using thresholds, such that variations between the time series that are greater than a threshold variation are not incorporated in the prediction. In some examples the read out function may provide a confidence score. In some examples, the confidence score can be obtained by a standard deviation operator, a weighted standard deviation operator, or any non-linear function like a deep network.

In some examples, the read-out function is a parametric model, such as a Gaussian model that takes the input from the time series following the key timestamp(s) and estimates the mean and standard deviation. In some examples, the output of the read-out function may include the mean, variance, confidence of projection, correlation, and/or consistency of the time series following the key timestamp(s).

In some examples, the read-out function is non-parametric, for example, a kernel density estimation function which uses a genetic algorithm to approximate the distribution of time series following the key timestamp(s). In some examples, the output of the read-out function may include variance, median, mode, and/or paths generated from Monte Carlo simulations that follow the distribution of the time series following the key timestamp(s).

In some examples, the read-out function provides a future distribution of the time series. The distribution may be used to determine mean, median, mode, variance, confidence of projection, correlation, consistency, and/or paths generated from Monte Carlo simulations that follow the distribution of the time series following the key timestamp(s).

In some examples, the read-out function may also compute risk metrics including the value-at-risk, and/or trailing stoploss, and may determine the predictive value-at-risk, which is a value-at-risk that is derived based on the prediction of the time series.

In some examples, a time series forecasting system may forecast multiple time series together. In some examples the system may generate covariance metrics may be generated from the future distributions of multiple assets estimated together. In some examples, the covariance metrics may be used to minimize the risk or maximize the return of the portfolio, based on an optimization function of the portfolio. In one type of optimization, the modern portfolio theory is used based on the distribution parameters that are derived from our future-looking system.

In some examples, techniques are provided for time series forecasting using a pattern matching-based machine learning model. The techniques may include obtaining (e.g., from one or more data sources) a target time series (e.g., the value of a particular asset, stock, commodity, or portfolio over a time period, such as over hours, days, months, or years), obtaining at least one reference time series (e.g., values of related assets, stocks, commodities or portfolios, macroeconomic conditions, microeconomic conditions, sentiment analysis related to the target time series, industry trend data, etc. over a time period corresponding to that of the target time series, such as the same time period or an overlapping time period) associated with the target time series. The techniques can include generating a self-similarity vector (e.g., a vector containing measures of similarity or distance, such as an Euclidean distance, a Pearson correlation, a spearman correlation, or a weighted distance function, etc.) for the reference time series by determining a similarity between a current time window of the reference time series (e.g., an hour, a day, a week, a month, etc. at a certain calendar time period within the overall time period of the reference time series) and one or more subsequences of the reference time series, different from the current time window (e.g., a week, a month, etc. at different calendar time period(s) that are within the time period of the reference time series). The techniques may include, based on the self-similarity vector, identifying one or more historic timestamps of the reference time series with similarity values above a threshold similarity value (e.g. the N timestamps with the highest similarity values may be selected, the timestamps above a threshold value based on the self-similarity vector, and/or reference or target time series may be selected, the timestamps above a user defined threshold value may be selected, or the timestamps above a predetermined threshold value may be selected). The techniques may include generating one or more future projections of the target time series based on the identified timestamps (e.g., projections of the variable of the target time series over a time period such as hours, days, weeks, or months, following the current time window, based on the timestamp data following the key timestamps). The techniques may also include generating a forecasting (e.g., a prediction of the time series, based on the future projections, which may include a mean, median, mode, variance, confidence of projection, correlation, standard deviation, consistency, and/or paths generated from Monte Carlo simulations of the target time series using a read-out function (e.g., averaging, thresholding, a standard deviation operator, a weighted standard deviation operator, a non-linear function, a parametric model, and/or a non-parametric algorithm).

As described herein, time-series forecasting using a multivariate pattern matching and integration algorithm may provide advantages over traditional techniques for time series forecasting. For example, the time series forecasting systems as described herein are trained on comparisons between the data immediately following historic timestamps within a time series. Further, the forecasting of a time series is performed based on historic timestamps which are most similar to a current timestamp of the time series, as opposed to a fixed time window of a time series. This allows for more accurate predictions to be made regarding a time series, as the predictions are made based on historic data which is similar to the current timestamp of the time series, as opposed to the entire time series or a fixed time window of the time series.

In addition, the techniques described herein involve updating the parameters used for prediction to those which will perform best based on the current state of the time series. This provides improved accuracy of predictions over traditional techniques using fixed time windows, because the data used for training is more representative of the current state of the time window.

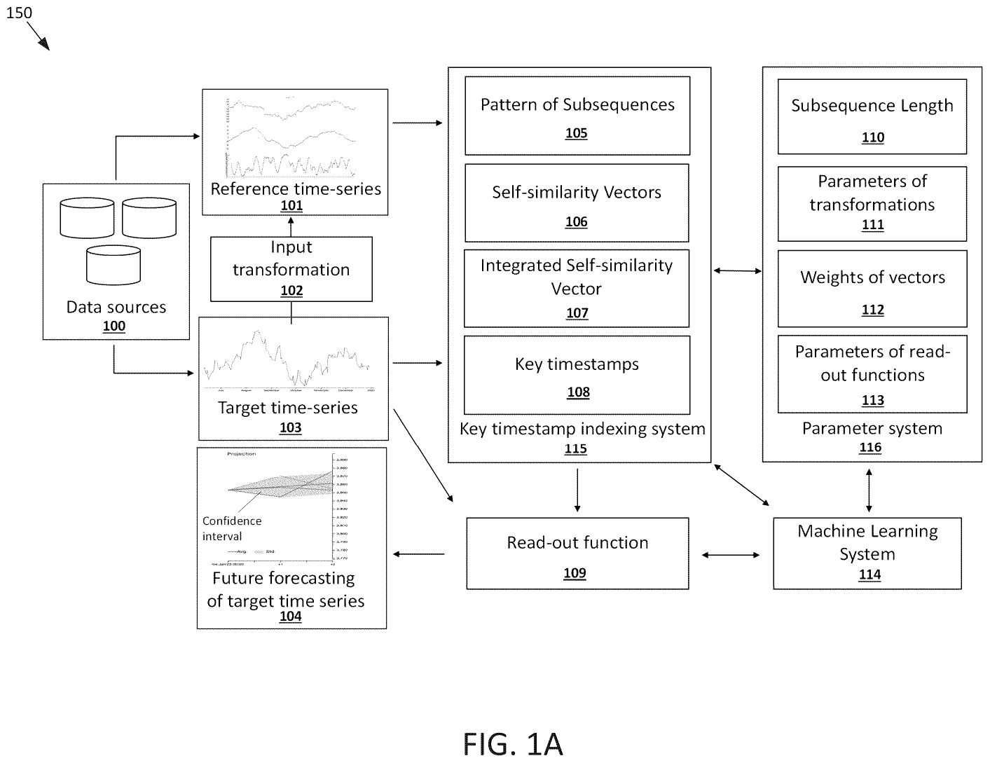

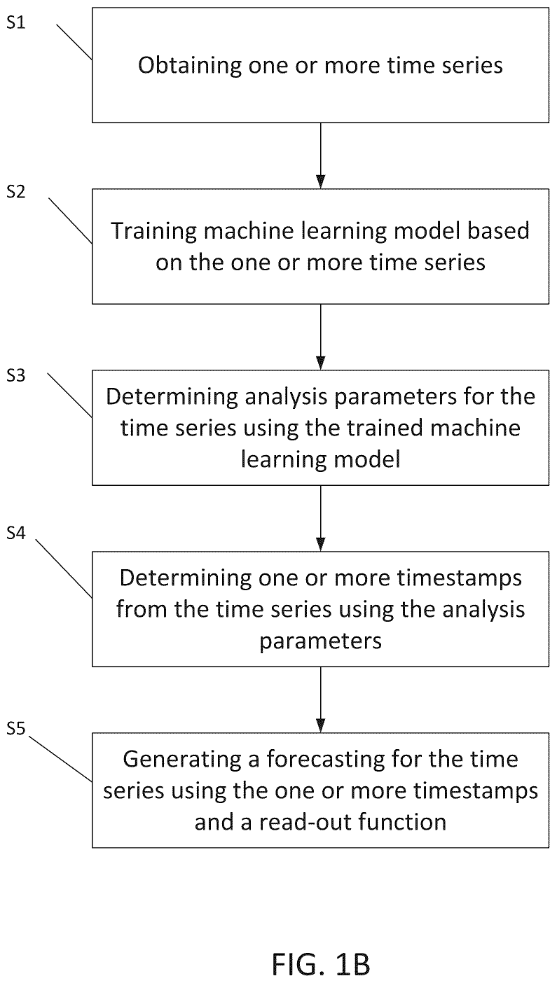

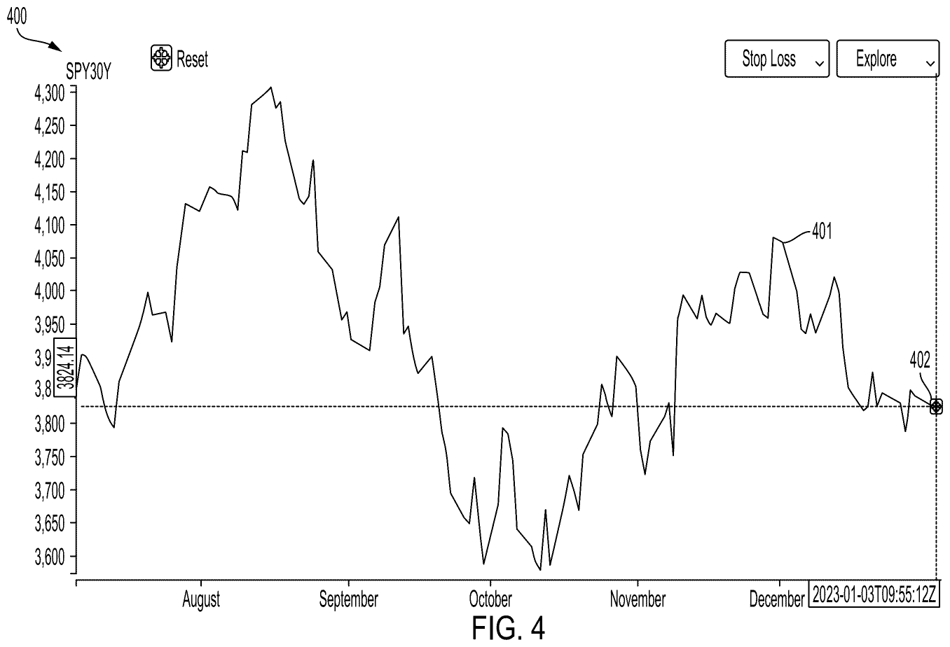

FIG. 1A is a diagram of an example system for time-series forecasting, according to some aspects of the technology described herein. The system 115 may function to forecast one or multiple future timestamps of a target time series 103. An example of a target time series is shown in FIG. 4.

FIG. 4 is a graph of an example time series, according to some aspects of the technology described herein. Time series 400 includes values for a particular variable over a time period. The Y axis of the graph depicts the value of the variable, and the X-axis of the graph depicts the time period over which the variable was tracked. Line 401 shows the value of the variable over the time period, up to current or most recent timestamp 402.

Returning to FIG. 1A, time series including target time series 103 and reference time series 101 may be obtained from one or more data sources 100. In some examples, the data sources may be data storage. In some examples, the data sources 100 may be a part of system 150. In some examples, the system 150 may record and update the time series contained within data sources 100. In some examples, the system 150 may obtain data from one or more external sources for storage in internal data sources 100, for example through one or more API calls to externals sources.

In some examples, the data sources 100 may be external to system 150. For example, the data sources may include websites, databases, financial exchanges, news sources, sentiment analysis on news sources, on-chain blockchain data, or other data which may be related to the current value of the variable of a time series. In some examples, the system 150 may obtain data, such as target time series 103 and/or reference time series 101, from external data sources 100 for immediate use in forecasting a target time series. For example, the system may make one or more API calls to external data sources 100 for data for analyzing a target time series.

In some examples, data sources 100 may include data sources contained within system 150 and external to system 150.

The system 150 contains three submodules, including key timestamp indexing system 115, parameter system 116, and machine learning system 114. The machine learning system 114 may determine one or more parameters of the parameter system 116, which may be used by the key timestamp indexing system 115 to determine key timestamps of a target time series 103.

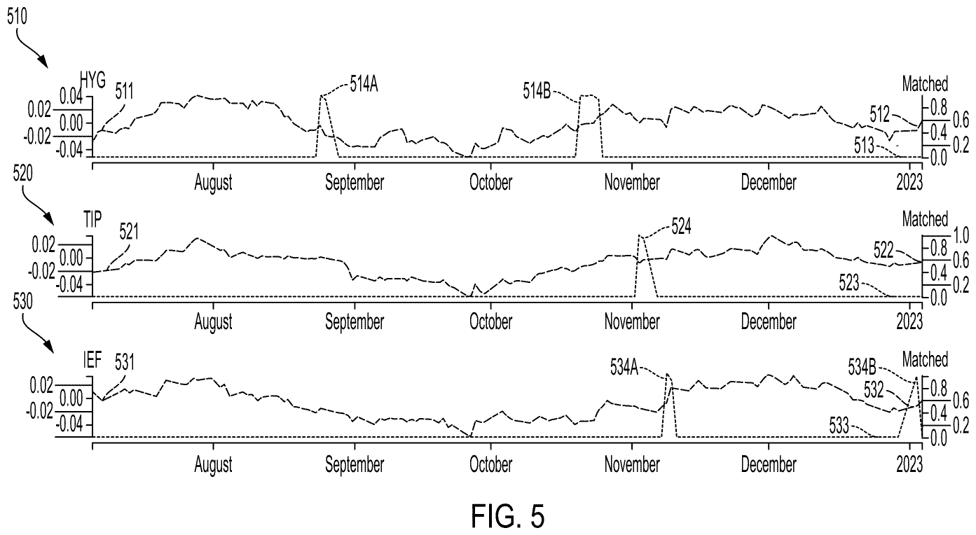

In some cases, a time-series future is not only dependent on its own history but one or more other time-series. In such cases, a reference time series 101 may be acquired for use in forecasting the future of the target time series. An example of a reference time series is provided in FIG. 5.

In some examples, the reference time series may be obtained in one or more ways.

In some examples, the time series 103 may contain noises and the system may perform one or more transformations on the target time series 103. The transformed target time series may be used by the system as a reference time series 101 in the forecasting of the target time series 103.

In some examples, the reference time series 101 may be obtained by direct use of the target time-series 103. In some examples, the reference time series 101 may be obtained by transforming the target time-series 103 using mathematic mappings 102.

In some examples, the reference time series 101 may be obtained by using other relevant time series without any information from the target time series 103. In some examples, the reference time series 101 may be obtained by transforming the target time series 103 along with other obtained time series.

In some examples, transformations, such as those used to obtain reference time series 101 from target time series, are general mathematic functions varies from linear transformations such as simple moving averages and rolling standard deviation to the more advanced non-linear transformation such as deep neural networks (transformers, generative models) and support vector regressors, etc., the parameters of the non-linear transformation can be obtained based on unsupervised or supervised machine learning algorithms implemented by machine learning system 114.

In some examples, reference time series 101 may include indicators generated from technical indicators such as Moving Average Convergence/Divergence (MACD), Relative Strength Index (RSI), stochastic K, and/or stochastic D. In some examples, the reference time series 101 may be derived from the forecasting of the target time series conducted by deep neural networks such as recurrent neural networks and/or transformer neural networks. In some examples, the reference time series may be derived from a positive/negative sentiment score generated from a large language model, such as GPT-1, GPT-2, GPT-3, GPT-3.5, GPT-4, and/or subsequent GPT versions. In some examples, the reference time series may be derived from a state sequence that indicates which regime the market, related to the target time series, is in, derived from a Hidden Markov Model. In some examples, the reference time series may be derived from graph properties about social networks such as number of nodes, edges, and/or forecasted graph properties derived from a graph neural network.

In some examples, before analyzing the target time series 103 and reference time series, the system 150 may perform processing on the target time series 103 and/or reference time series. For example, the system 150 may process the target time series 103 and/or reference time series by filtering the time series to reduce noise, annotating the time series to identify specific known events, formatting of the time series, alignment of the time series, or performing one or more transformations on the time series, as described herein.

After obtaining the target time series 103 and reference time series 101, and any processing is performed, the system 150 may pass the target time series 103 and reference time series to the key timestamp indexing system 115.

The key timestamp indexing system 115 may analyze the target time series 103 and/or reference time series 101 to determine one or more key timestamps of the target time series 103 which are related to a current or most recent timestamp of the target time series. The key timestamp indexing system 115 may utilize parameters stored within parameter system 116 to determine the one or more key timestamps.

All the parameters used by key timestamp indexing system 115 and parameters of read-out function 109 are saved in the parameter system 116. In some examples, the parameters in parameter system 116 can be set by a user of the system 150. In some examples, the machine learning system 114 may determine the parameters saved in the parameter system 116. In some examples, the machine learning system 114 may determine and optimize parameters through stochastic gradient descent, coordinate descent, and/or automatic machine learning models (AutoML). In some examples, some parameters saved in the parameter system 116 may be determined by a user of the system 150 and some parameters saved in the parameter system 116 may be determined by the machine learning system 114.

The key timestamp indexing system 115 may slice the reference time series 101 and target time series 103 into sub sequences. Each subsequence of the reference time series 101 and the target time series 103 may have a subsequence length which is determined by the subsequence length 110 saved within parameter system 116. The sequence length may be determined by a user of the system 150 or by machine learning system 114, based on historic data. In some examples, the subsequences determined for each reference time series may have the same length. In some examples, the subsequences determined for each reference time series may have different lengths.

For each reference time series 101, the pattern of the subsequences 105 of the reference time series is compared with each other, and a distance function is applied to compute the similarity (or distance) between the most recent subsequence and the other subsequences of the reference time series. In some examples, the distance function involves mathematic operators that output Euclidean distance, Pearson correlation, spearman correlation, etc. In some examples, the distance function is a weighted distance function in which elements of the subsequences are weighted differently. For example, some elements may be weighted higher as they are more important indicators for the time series forecasting than others. In some examples, the weights may be manually assigned by a user of the system or may be derived based on one or more indicators such as a trading volume or values of other reference time series. In some examples, the similarity between subsequences of a reference time series may be determined using a machine learning model. For example, be computed using a machine learning model implemented with “sklearn.metrics”, “metric-learn”, “Pytorch”, “tensorflow”, “Auto-sklearn”, “H2O AutoML”, among other machine learning packages.

The pair-wise similarity values for the subsequences are concatenated for each time series to generate a self-similarity vector 106 for each reference time series.

FIG. 5 is a diagram of example reference time series, according to some aspects of the technology described herein. FIG. 5 shows three reference time series charts, 510, 520 and 530. Each of the three reference time series includes a respective graph of variable values, shown by lines 511, 521, and 531. The graph of variable values depicts the value of the variable of the reference time series over a time period, up to a current or most recent timestamp, 521, 522, and 532.

The reference time series charts 510, 520 and 530 of FIG. 5 additionally include respective self-similarity vectors 513, 523 and 533. The self-similarity vectors may be calculated as described herein. The self-similarity vectors represent how similar the most recent timestamp, 512, 522, and 532, of the reference time series, 511, 521 and 531, is to other timestamps within the time series. As shown, the most recent timestamp 512 is most similar to timestamps 514A and 514B, indicated by the increased value of the self-similarity vector 513. As shown, the most recent timestamp 522 is most similar to timestamp 524, indicated by the increased value of the self-similarity vector 523. As shown, the most recent timestamp 532 is most similar to timestamps 534A and 534B, indicated by the increased value of the self-similarity vector 533.

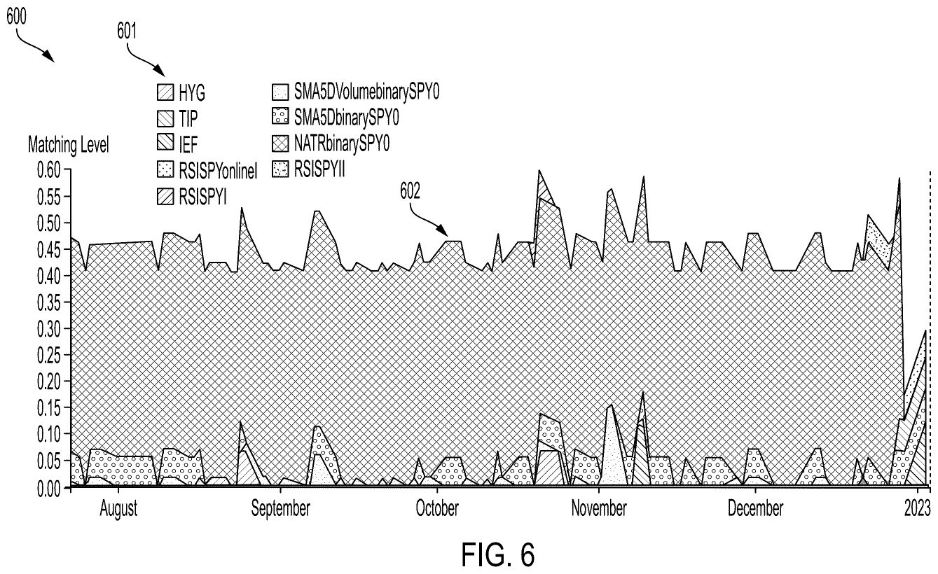

Returning to FIG. 1A, the self-similarity vectors are then integrated into an integrated similarity vector 107 using an integration function k( ). Values of an example integrated similarity vector are depicted in FIG. 6. In some examples, the integration function can be a linear weighted average operator, with the weights applied to the self-similarity vectors 112, being determined by user or by a machine learning algorithm 114 during the pre-training phase. In some examples, the integration function contains a non-linear mapping such as a weighted average followed by a sigmoid function. In some examples the integration function is a deep neural network.

FIG. 6 is a diagram of an example integrated self-similarity vector, according to some aspects of the technology described herein. The graph 600 includes multiple self-similarity vectors from different reference time series and an integrated self-similarity vector 602. The legend 601 shows the shadings which are associated with each of the self-similarity vectors of the reference time series. The integrated self-similarity vector 602 may be determined by integrating the values of the individual self-similarity vectors, as described herein. Key timestamps may be identified from the integrated self-similarity vector based on the highest values of the integrated self-similarity vector 602.

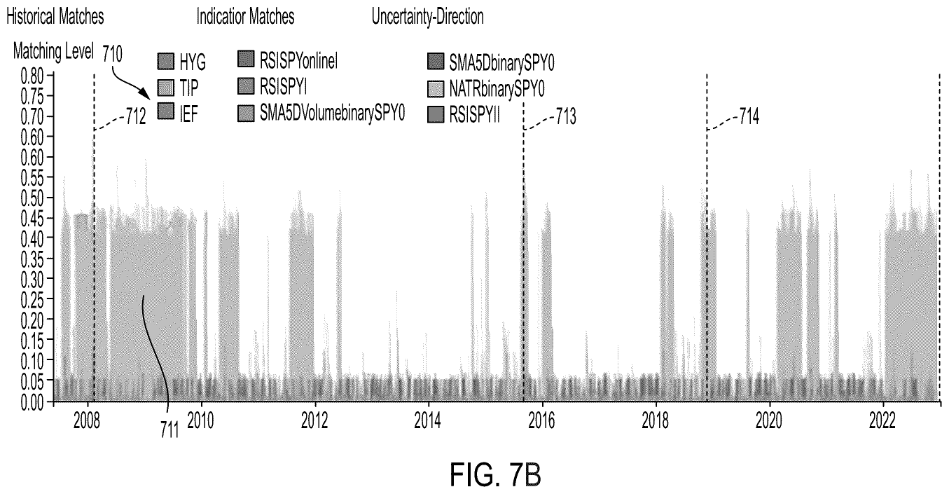

FIG. 8 is a diagram of example parameters of two reference time series, according to some aspects of the technology described herein. FIG. 8 includes reference time series 810 and 820. The self-similarity vector of reference time series 810 is calculated using a subsequence length 812 of 5 timestamps, and weight 811 of 0 is applied to the self-similarity vector when determining the integrated self-similarity vector. The self-similarity vector of the reference time series 820 is calculated using a subsequence length 822 of 3 timestamps and a weight 821 of 69 is applied to the self-similarity vector when determining the integrated self-similarity vector. The weights 811 and 821 and lengths 812 and 822 may be determined by a user or a machine learning system, as described herein. The weight of reference time series 820 may be higher than that of reference time series 810 because the data of the reference time series 820 is more important or influential to the target time series than the data of reference time series 810.

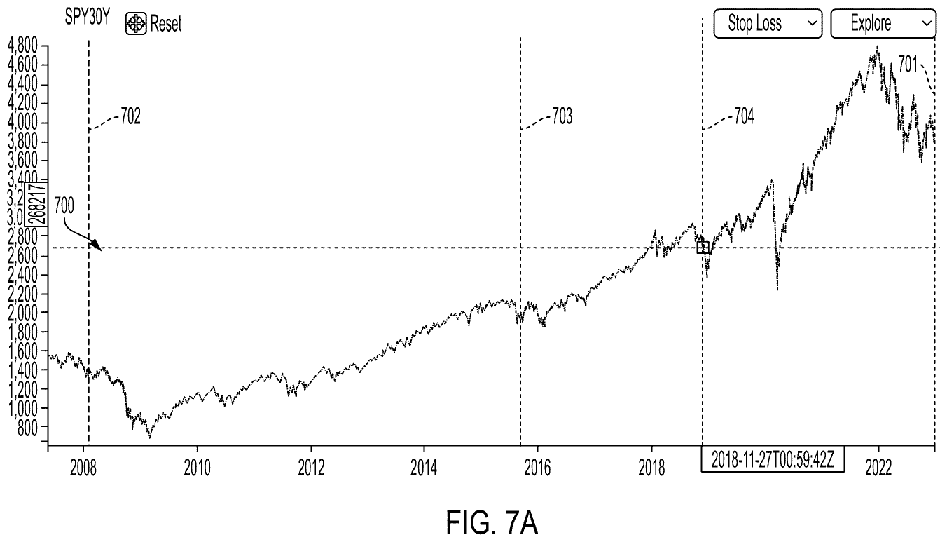

Returning to FIG. 1A, key timestamps 108 may be identified by the key timestamp indexing system 115 based on the integrated self-similarity vector. In some examples, the key timestamps 108 may be identified when the value of a timestamp of the integrated self-similarity vector is above a threshold value. For example, the system may determine a threshold value based on the self-similarity vector, and/or reference or target time series, a user of the system may determine a threshold value, or a predetermined threshold value may be used. In some examples, the threshold value may be determined by a user of the system 150 or by machine learning system 114. In some examples, a predetermined number of the highest value timestamps may be identified as key timestamps 108. For example, the five timestamps of the integrated self-similarity vector with the highest values may be identified as the key timestamps 108. It should be appreciated that any number of key timestamps may be identified, for example, one key timestamp, two key timestamps, three key timestamps, four key timestamps, five key timestamps, between one and ten key timestamps, at least 10 key timestamps, at least 20 key timestamps, or at least 50 key timestamps. An example of identifying key timestamps from an integrated self-similarity vector is shown in FIG. 7.

FIG. 7 is a diagram of an example process for determining timestamps from a self-similarity vector, according to some aspects of the technology described herein. FIG. 7 includes graphs of the target time series 700 and integrated self-similarity vector 710. Both the target time series and integrated self-similarity vector are aligned temporarily. The values 711 of the integrated self-similarity vector 710 represent how similar a historic timestamp is to a current timestamp of the target time series 700. As shown the current or most recent timestamp of the target time series 700 is shown as timestamp 701.

Three key timestamps, 712, 713, and 714, were identified from integrated self-similarity vector 710. These key timestamps may be identified as described herein. These three key timestamps are also shown on target time series 700 as lines 702, 703 and 704. The key timestamps identified for a particular target time series may be used in the forecasting of the time series.

Returning to FIG. 1A, for each of M identified key timestamps, the future N timestamps in the target time series, following the key timestamps are recorded, which are used as a possible future projection of the target time-series. A M×N forecasting matrix is generated where M is the number of key timestamps and N is the number of future timestamps. The key timestamp indexing system may pass the forecasting matrix to the read-out function 109. The readout function may generate a forecasting of the time series, as described herein.

The forecasting matrix is finally summarized into the future forecasting 104 of the target time series using a read-out function 109. The read-out function can be non-parameterized such as an average function and the future forecasting becomes a simple average of the future N timestamps of the M key timestamps or parameterized by considering the value of the integrated similarity vector.

In some examples, the read-out function generates a confidence interval that represents how the future projections are consistent with each other in terms of the percentage increase or decrease. The confidence score can be obtained by a standard deviation operator, a weighted standard deviation operator, or any non-linear function like a deep network, etc.

In some non-limiting embodiments or aspects, the read-out function 109 contains user-defined or machine learning 114 assigned thresholds, the thresholds are taking effects as a binary function where any values deviate from the thresholds are converted into zero and any values within the thresholds are converted into one, and vice versa.

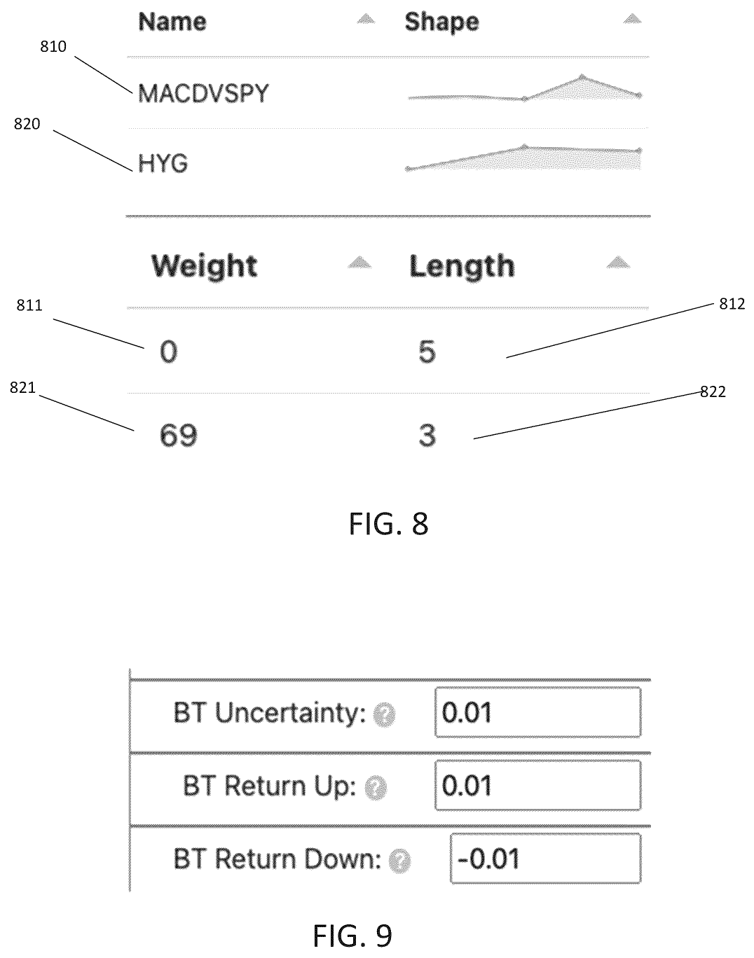

FIG. 9 is a diagram of example parameters of a read-out function, according to some aspects of the technology described herein. The parameters of FIG. 8 include an uncertainty parameter, a return up parameter and a return down parameter. These parameters may be used by a read-out function in determining the forecasting of a time series, as described herein.

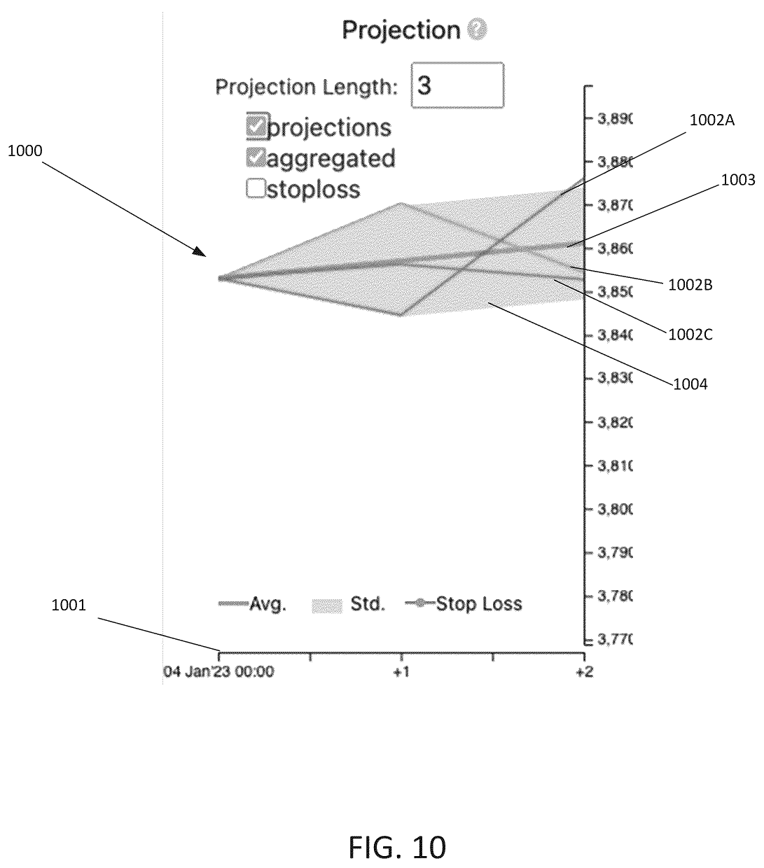

FIG. 10 is a diagram of an example time series forecasting, according to some aspects of the technology described herein. The forecasting 1000 of FIG. 10 may be provided as an output of a time series forecasting system, as described herein. The forecasting 1000 may be determined by a read-out function, as described herein.

The forecasting 1000 begins at timestamp 1001, which is the most recent timestamp of the target time series which is forecasted. The timestamps of the time series forecasting are shown on the X axis and the forecasted values of the variable of the time series are shown on the Y axis. Three predictions, 1002A, 1002B and 1002C, are shown, which may correspond to individual key timestamps determined for the target time series. The predictions 1002A-C may be determined by using the behavior of the target time series for timestamps following each of the respective key timestamps and projecting from the most recent timestamp 1001 based on this behavior. In some examples, the timestamps following each of the identified key timestamps may be directly used for predictions 1002A-C, with adjustments made to begin at the most recent value of the time series. In some examples, the predictions 1002A-C may be determined by using different parameters of the read out function for each prediction, using different prediction functions for each prediction, and/or by using data associated with one or more of the key timestamps for each prediction.

The three predictions 1002A, 1002B and 1002C may be used to determine forecasting 1003. In some examples, the three predictions may be averaged to determine the forecasting 1003, however other techniques may be used, as described herein. Confidence interval 1004 represents the uncertainty in the forecasting 1003, as described herein.

Returning to FIG. 1A, the values of the future forecasting 104 of target time series 103 may be used to inform one or more decisions related to the target time series. In some examples, the system 150 may be configured to automatically perform one or more actions based on the future forecasting 104. In some examples, the system 150 may automatically perform one or more actions when the values of forecasting 104 are above or below a threshold value.

FIG. 1B is a flow chart for an example process for performing time-series forecasting using a system, according to some aspects of the technology described herein. The process of FIG. 1B may be performed using a system such as system 150 of FIG. 1A.

The process begins at step S1, in which one or more time series are obtained. The one or more time series may include a target time series, as described herein. In some examples, the one or more time series may include one or more reference time series as described herein. The one or more time series may be obtained from data sources, such as data sources 100 as discussed regarding FIG. 1A, as described herein. In some examples, the system may perform processing on the one or more time series after obtaining the time series, as described herein.

The process may then proceed to step S2, in which a machine learning model is trained based on the one or more time series. The machine learning model may be contained in a machine learning system, such as machine learning system 114 of FIG. 1A. The machine learning model may be trained as described herein.

The process may then proceed to step S3, in which analysis parameters for the time series are determined using the trained machine learning model. The analysis parameters may include subsequence lengths, parameters of transformations, vector weights, and read-out function parameters, among other parameters, as described herein. After the analysis parameters are determined, they may be stored in a parameter system, such as parameter system 116 of FIG. 1A, as described herein. In some examples, the parameters may be determined at least in part by a user of the system, as described herein.

The process may then proceed to step S4, in which one or more timestamps are determined from the time series using the analysis parameters. The timestamps may be key timestamps, as described with reference to FIG. 1A. The timestamps may indicate timestamps within the time series most similar to a most recent timestamp of the timeseries. Step S4 may be performed by a key timestamp indexing system, such as 115 as described related to FIG. 1A.

The process may then proceed to step S5, in which a forecasting is generated for the time series using the one or more timestamps and the read-out function. The forecasting may be determined as described herein, such as with regard to FIG. 1A and FIG. 7. The forecasting may include one or more predictions, and/or a confidence interval, as described herein. The forecasting may be provided to a user of the system, such as through a user interface, as described herein.

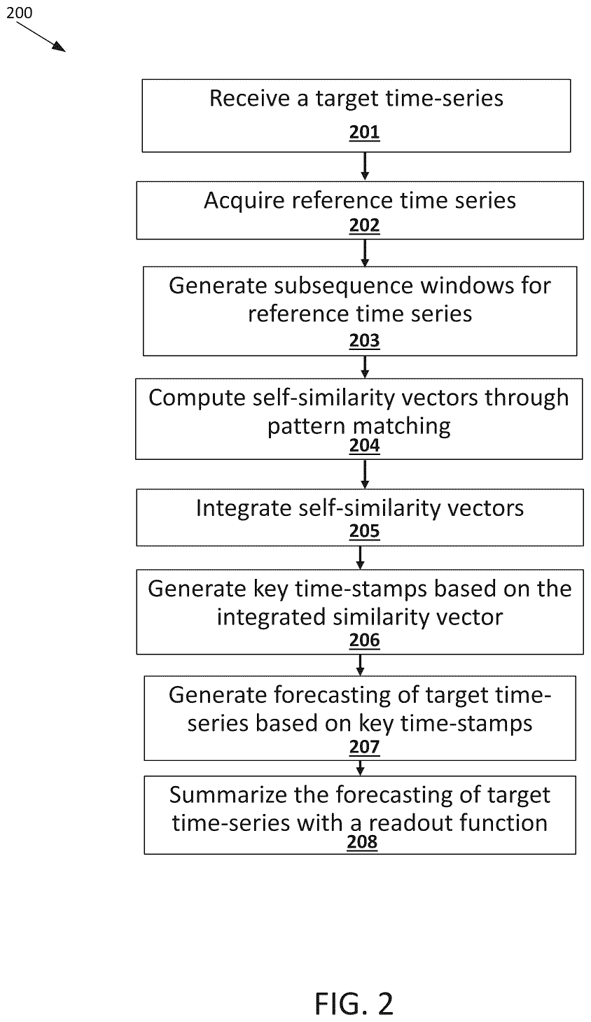

FIG. 2 is a flow chart of an example process for performing time series forecasting, according to some aspects of the technology described herein.

The process 200 begins at step 201, in which a target time series is received. The target time series may be received from data sources as described herein. The target time series may be processed after it is received, as described herein.

The process 200 may then proceed to step 202 in which reference time series are acquired. Reference time series may be acquired as described herein, for example from data sources or from the target time series.

The process 200 may then proceed to step 203, in which subsequence windows are generated for the reference time series. Step 203 may be performed by a key timestamp indexing system, such as 115 of FIG. 1A. Each reference time series may be sliced into multiple subsequences. The length of the subsequence windows may be determined by a user of the system or by a machine learning model, as described herein. The lengths of the subsequence windows for each reference time series may be the same length or different lengths, as described herein.

The process 200 may then proceed to step 204, in which self-similarity vectors are computed through pattern matching of the subsequence windows. Step 204 may be performed by a key timestamp indexing system, such as 115 of FIG. 1A. The self-similarity vectors may be computed, as described herein. The self-similarity vectors may be computed by comparing the most recent or current subsequence of each reference time series to the other subsequences of that time series.

The process 200 may then proceed to step 205, in which the self-similarity vectors are integrated. Step 205 may be performed by a key timestamp indexing system, such as 115 of FIG. 1A. The self-similarity vectors determined for each of the reference time series may be integrated into an integrated self-similarity vector as described herein.

The process 200 may then proceed to step 206, in which key timestamps are generated based on the integrated self-similarity vector. The key timestamps may be determined as described herein. Step 206 may be performed by a key timestamp indexing system, such as 115 of FIG. 1A.

The process 200 may then proceed to step 207, in which the forecasting of the target time series is generated based on the key timestamps. The forecasting may be generated as described herein, for example by using timestamps immediately following each of the key timestamps as predictions. The forecasting may then be summarized using a read-out function in step 208. The read-out function may summarize the forecasting of the time series, as described herein.

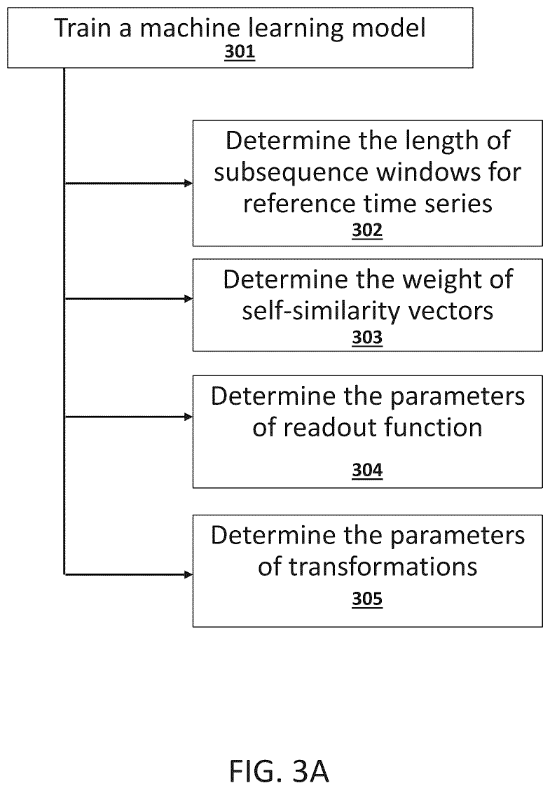

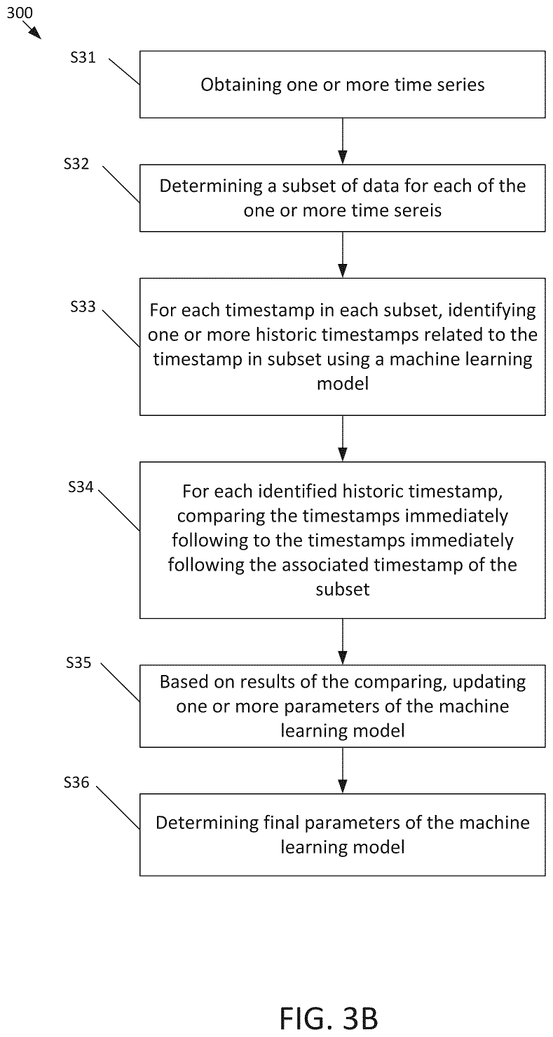

FIG. 3A is a flowchart of an example process for learning the parameters used in integrable multivariate pattern matching, according to some aspects of the technology described herein. In FIG. 3A, a machine learning model is trained 301 to determine one or more parameters to be used by a time series forecasting system. The parameters may be determined and optimized through stochastic gradient descent, coordinate descent, and/or AutoML.

The machine learning system may be applied to learn and update the length of subsequence windows for reference time series 302. The subsequence window lengths may be used by a time series forecasting system to slice reference time series into subsequences.

The machine learning system may additionally be applied to learn and update the weight of self-similarity vectors 303. The self-similarity vector weights may be used during the integration of self-similarity vectors into an integrated self-similarity vector, as described herein. Different weights may be given to different self-similarity vectors based on the correlation of the associated reference time series with the target time series, as described herein. In some examples, the machine learning system may be updated based on a loss function in which the consistency between the directions of the time series following key timestamps is maximized.

The machine learning system may additionally be applied to learn and update the parameters of read-out function 304.

The machine learning system may additionally be applied to learn and update the parameters of transformation 305. In some examples, the transformations in 305 include the mapping of an input transformation, such as 102 of FIG. 1A, the mapping from of subsequences to self-similarity vectors, such as from 105 to 106 in FIG. 1A, and the mapping from self-similarity vectors to an integrate self-similarity vector, such as 106 to 107 in FIG. 1A.

FIG. 3B is a flowchart of an example process for training a machine learning model for time series forecasting parameters, according to some aspects of the technology described herein. The process 300 may be used to train a machine learning model such as 114 of FIG. 1A.

In some examples, a user of the system may input the information to be used in training, such as in process 300. For example, the user may specify the target time series, the time scale of the time series (e.g., the time between successive timestamps of the time series), and the forecasting period (e.g., the future time window the target time series will be forecasted into). For example, the user may select a particular stock for forecasting, a time scale of one day and a forecasting period of five days, however a user may select any value suitable for their particular application.

In some examples, the user may additionally or alternatively define initial weights and parameters of indicators (e.g., reference time series, and model parameters) for use in training. For example, a user may define weights and lengths for a Moving Average Convergence Divergence Volume Indicator, 200-Day Simple Moving Average Indicator, an open value indicator, a close value indicator, a high value indicator, and/or a low value indicator. For example, the user may select equal weights, such as 1, and equal lengths, such as 5 days, for the initial values of the indicators, however a user may select any value suitable for their particular application. For example, if a user believes that the 200-Day Simple Moving Average indicator is highly indicative of the target time series, they may select a higher weight such as 5. In some examples, a user may define certain indicators not to be optimized during training, and the user defined values will be used by the system. During training, the machine learning model may automatically optimize the weights and lengths defined by the user according to the time series, time scale and forecasting period defined by the user. The machine learning model may additionally determine parameters for time series forecasting, such as those stored within parameter system 116 of FIG. 1.

The process 300 begins at step S31, in which one or more time series are obtained. The time series may be obtained as described herein. The time series may include a target time series and/or reference time series as described herein.

The process 300 may then proceed to step S32 in which a subset of data is determined for each of the one or more time series. The subset of data may be the most recent time period of data, for example data from the last day, week, month or year of the time series. In some examples, the subset may be randomly selected. In some examples, the subset may be a continuous sequence of the time series. In some examples, the subset is not a continuous sequence of the timeseries. The length of the subset may be determined based on the forecasting to be performed by the machine learning model. For example, if the machine learning model is to forecast the next hours of a time series, the subsets may be hours to days in length. Whereas if the machine learning model is to forecast the next month of a time series, the subset may be months to years in length. In some examples, the length of the subset may be manually specified by a user of the system. Each subset contains multiple timestamps with a value for the variable of the time series. In some examples, the subsets may be determined based on the most recent number of timestamps of the time series, for example the most recent 10, 50, 100, 500, 1000, 10,000, 100,000, 1,000,000, or greater than 1,000,000 timestamps.

The process 300 may then proceed to step S33, in which for each timestamp in each subset, one or more historic timestamps are identified using the machine learning model. In some examples, each timestamp of each subset may not be analyzed and select timestamps from the subset(s) may be analyzed. The one or more historic timestamps may be identified from the data of the time series not included in the subset. In some examples, the one or more historic timestamps may be identified from data included in the subset. The number of historic timestamps identified may be any suitable number of historic timestamps, for example one historic timestamp, 5 historic timestamps, 10 historic timestamps, 20 historic timestamps, or greater than 20 historic timestamps. In some examples, the number of historic timestamps identified may be determined by a user of the system. The historic timestamps may be identified based on a similarity to the associated timestamp of the subset, with the most similar timestamps being selected as historic timestamps.

The process 300 may then proceed to step S34, in which for each historic timestamp identified in step S33, the timestamps immediately following the historic timestamp are compared to the ground truth timestamps immediately following the associated timestamp of the subset. The comparison may involve comparing trends or directions of change in the timestamps, for example if the ground truth timestamps are increasing following the timestamp of the subset, the timestamps immediately following the historic timestamp may be analyzed to see if they are increasing, similar to the ground truth timestamps.

The comparison may provide an indication of how similar the timestamps following a historic timestamp are to the ground truth timestamps following a timestamp of the subset. When the comparison indicates there is a high similarity, the behavior of the time series immediately following a particular timestamp of the subset may be accurately predicted based on historic timestamps of the time series. This is because historic data is being used to predict historic data. The behavior of the time series within the subset is known and therefore may be used as ground truth data in a training of the machine learning model based on historic data of the time series. In some examples, the number of timestamps immediately following either the historic or subset timestamps used for comparison may be determined by a user of the system. In some examples, the number of timestamps used for comparison may be determined based on the length of forecasting to be performed by the machine learning model.

The process 300 may then proceed to step S35, in which one or more parameters of the machine learning model are updated based on the results of the comparing. In some examples, the comparing may involve determining a loss function based on the difference between a prediction based on the historic time points and the known behavior of the time series within the subset. The parameters may be updated to minimize the value of the loss function, such that the updated parameters provide a more accurate prediction, with the identified historic timestamps being more similar to the associated to the associated timestamps of the subset. The parameters may be determined and optimized based on the comparison through stochastic gradient descent, coordinate descent, and/or AutoML.

In some examples, the parameters which are updated in step S35 include one or more of a subsequence length, transformation parameters, vector weights, and read-out function parameters, among other parameters, as described herein.

In some non-limiting embodiments or aspects, during the training, the machine learning model is learned to minimize a loss function defined on a batch of random selected samples. The loss function can be defined to minimize: i) the forecasted values on the selected timestamps from the subset, ii) the actual values of the selected timestamps of the subset.

The process 300 may then proceed to step S36, in which final parameters of the machine learning model are determined. The final parameters may then be used in time series forecasting, as described herein.

In some examples, final parameters of the machine learning model may be determined after the results of the comparing indicate a difference between the timestamps following the historic timestamps and the data following the associated timestamps of subset is below a threshold difference. In some examples, final parameters of the machine learning model may be determined after a maximum number of training iterations are performed. In some examples, the final parameters of the machine learning model may be determined when the system converges on a set of parameter values. Steps S33-S35 may be repeated until the difference is below the threshold difference, a maximum number of iterations are performed, or the system converges.

In some examples, in each iteration, the length and weights of some parameters are determined first by optimizing a loss function to minimize the projection (residual) error of the historic timestamps, and the parameters of read-out function are optimized to maximize the projection (residual) error of the whole time-series. In some examples, the process of optimizing lengths, weights, and other parameters are run alternately until the system converges or reaches a predefined maximum number of iterations.

In some examples, the difference may be determined to be below a threshold when a loss function reaches a minimum, or when successive parameter updates result in a change in parameters which are below a threshold change.

In examples, during the process 300, the machine learning model can also contain a term in the loss function that minimizes the reconstructed error of the historic target time series, or a perturbed version of it.

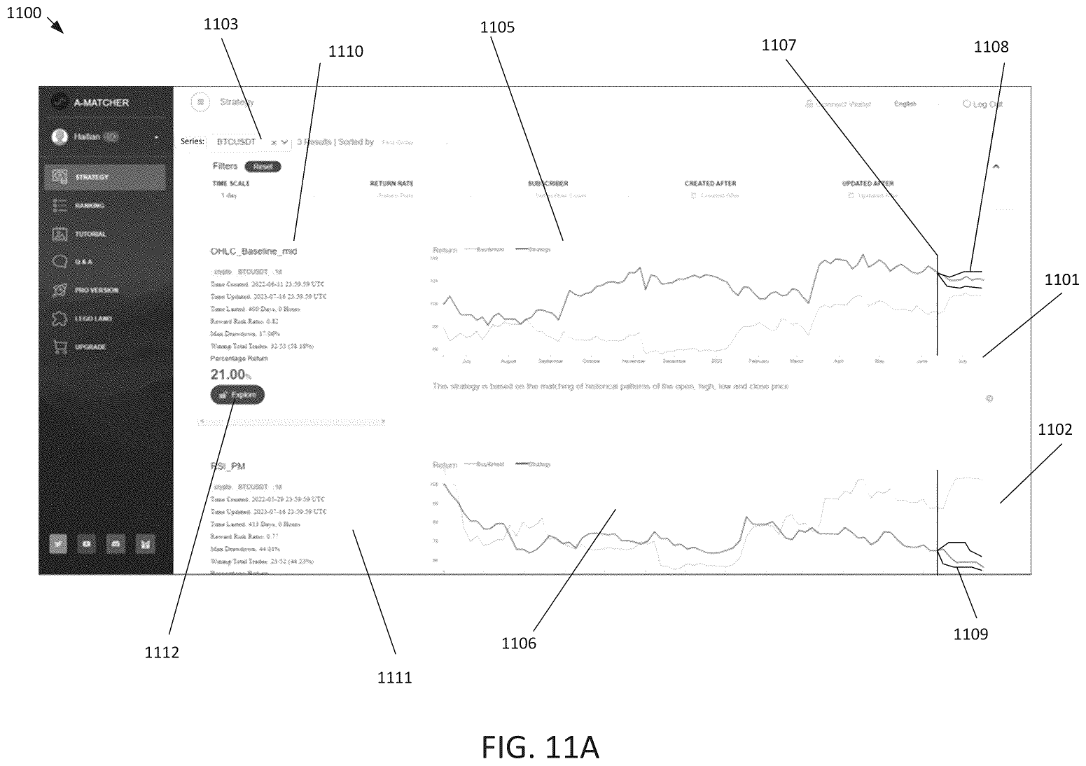

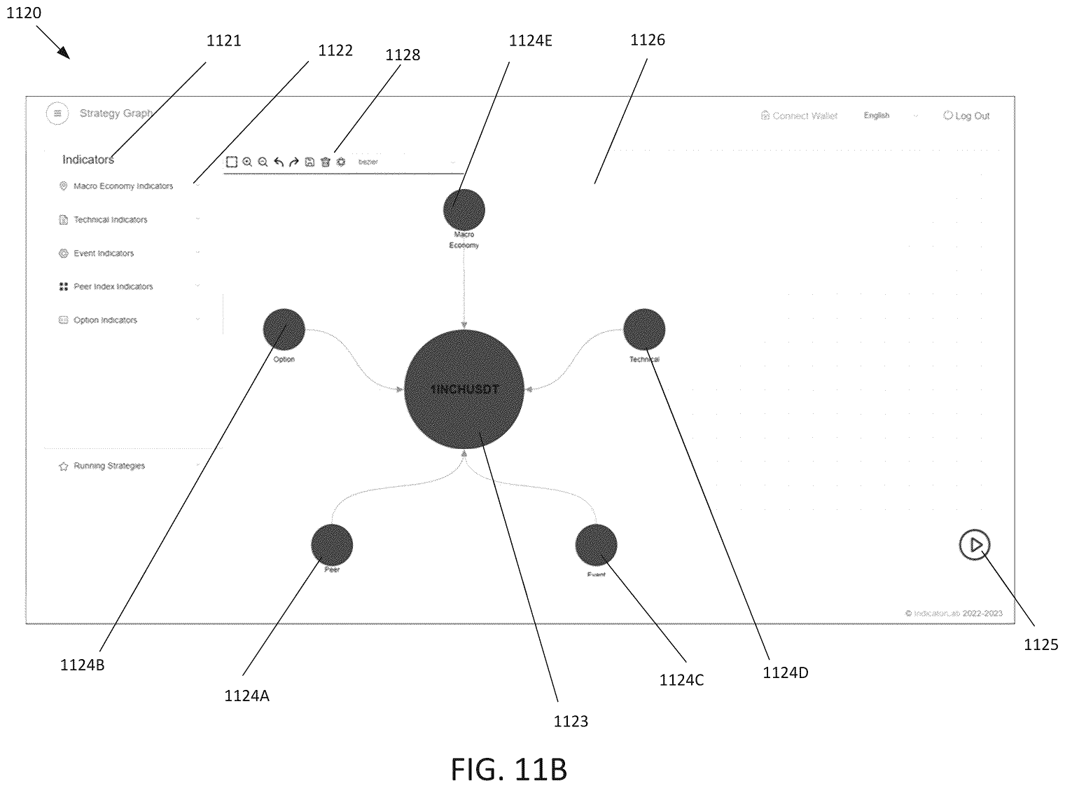

FIG. 11A is a diagram of an example user interface dashboard, according to some aspects of the technology described herein. The user interface may be used by a time series forecasting system, such as system 150, as described herein. The user interface 1100 includes displays of one or more time series such as time series 1101 and 1102. Time series may be added or removed from the display using time series selector 1103.

Each time series display, 1101 and 1102, include respective graphs of time series data, 1105 and 1106. The graphs may include historic data, a current time point 1107, and time series forecasts. The time series forecast of time series data 1105 is shown as 1108. The time series forecast of time series data 1106 is shown as 1109.

Each time series display, 1101 and 1102, include time series parameters, 1110 and 1111, respectively. The time series parameters may include information about the time series, and information about the parameters used to determine the time series forecasting. The time series display 1101 additionally includes input 1112, which may allow a user of the system to view and/or change one or more parameters or aspects of the time series.

FIG. 11B is a diagram of an example model building user interface, according to some aspects of the technology described herein. The user interface 1120 may be used to build a model for forecasting of a target time series, as described herein. The target time series 1123 may be forecasted based on one or more reference time series 1124A-E. The user interface 1120 allows a user to upload or select a target time series 1123, and to upload or select one or more reference time series for use in forecasting the target time series. The user may use chart display 1126 to place time series and connect time series, with the central time series 1123 being the target time series and each connected time series 1124A-E being used as a reference time series. The user may drag and drop time series onto the chart display from time series menu 1121. The time series menu may include drop down lists such as 1122 of time series available for the user in building their model for forecasting. The time series within menu 1121 may be available to the user via the internet or another network, may have been uploaded by the user for forecasting, or may otherwise be obtained as described herein. The user may save, edit, undo, redo or discard any changes to the model using toolbar 1128. After preparing the model, the user may start a forecasting of the target time series by selecting start button 1125.

The user interface 1120 allows a user without significant technical skill to build a model for multivariate based time series forecasting. The user interface 1120 allows for a no-code approach where the user may define some or all of the parameters and time series used in the forecasting via the user interface 1120, and the system will perform the forecasting, as described herein.

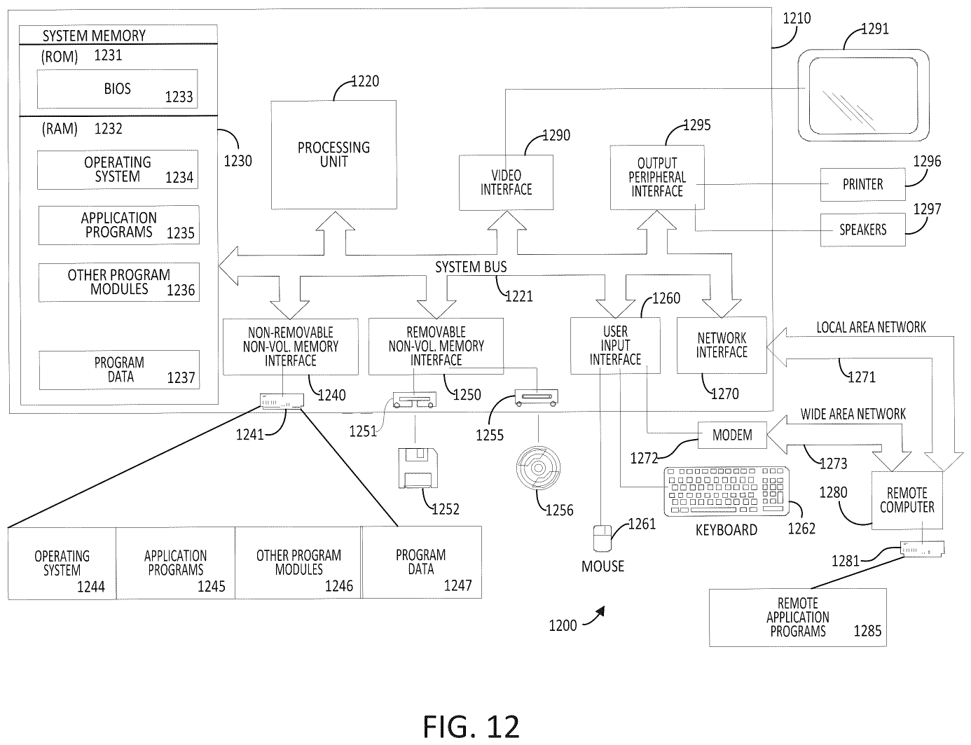

FIG. 12 shows a block diagram of an exemplary computing device, in accordance with some embodiments of the technology described herein. The computing system environment 1200 is only one example of a suitable computing environment and is not intended to suggest any limitation as to the scope of use or functionality of the technology described herein.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 12, an exemplary system for implementing the technology described herein includes a general-purpose computing device in the form of a computer 1210. Components of computer 1210 may include, but are not limited to, a processing unit 1220, a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1210 typically includes a variety of computer readable media. Computer readable media can be any available media that can be accessed by computer 1210 and includes both volatile and nonvolatile media, removable and non-removable media. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 1210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1230 includes computer storage media in the form of volatile and/or nonvolatile memory such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data and/or program modules that are immediately accessible to and/or presently being operated on by processing unit 1220. By way of example, and not limitation, FIG. 12 illustrates operating system 1234, application programs 1235, other program modules 1236, and program data 1237.

The computer 1210 may also include other removable/non-removable, volatile or nonvolatile computer storage media. By way of example only, FIG. 12 illustrates a hard disk drive 1241 that reads from or writes to non-removable, nonvolatile magnetic media, a flash drive 1251 that reads from or writes to a removable, nonvolatile memory 1252 such as flash memory, and an optical disk drive 1255 that reads from or writes to a removable, nonvolatile optical disk 1256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1241 is typically connected to the system bus 1221 through a non-removable memory interface such as interface 1240, and magnetic disk drive 1251 and optical disk drive 1255 are typically connected to the system bus 1221 by a removable memory interface, such as interface 1250.

The drives and their associated computer storage media described above and illustrated in FIG. 12, provide storage of computer readable instructions, data structures, program modules and other data for the computer 1210. In FIG. 12, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237. Operating system 1244, application programs 1245, other program modules 1246, and program data 1247 are given different numbers here to illustrate that, at a minimum, they are different copies. An actor may enter commands and information into the computer 1210 through input devices such as a keyboard 1262 and pointing device 1261, commonly referred to as a mouse, trackball, or touch pad. Other input devices (not shown) may include a microphone, joystick, game pad, satellite dish, scanner, or the like. These and other input devices are often connected to the processing unit 1220 through a user input interface 1260 that is coupled to the system bus, but may be connected by other interface and bus structures, such as a parallel port, game port or a universal serial bus (USB). A monitor 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1295.

The computer 1210 may operate in a networked environment using logical connections to one or more remote computers, such as a remote computer 1280. The remote computer 1280 may be a personal computer, a server, a router, a network PC, a peer device, or other common network node, and typically includes many or all of the elements described above relative to the computer 1210, although only a memory storage device 1281 has been illustrated in FIG. 12. The logical connections depicted in FIG. 12 include a local area network (LAN) 1271 and a wide area network (WAN) 1273, but may also include other networks. Such networking environments are commonplace in offices, enterprise-wide computer networks, intranets, and the Internet.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. The modem 1272, which may be internal or external, may be connected to the system bus 1221 via the actor input interface 1260, or other appropriate mechanism. In a networked environment, program modules depicted relative to the computer 1210, or portions thereof, may be stored in the remote memory storage device. By way of example, and not limitation, FIG. 12 illustrates remote application programs 1285 as residing on memory device 1281. It will be appreciated that the network connections shown are exemplary and other means of establishing a communications link between the computers may be used.

Having thus described several aspects of at least one embodiment of the technology described herein, it is to be appreciated that various alterations, modifications, and improvements will readily occur to those skilled in the art. Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, a tablet computer, a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. A computer-readable storage medium includes any computer memory configured to store software, for example, the memory of any computing device such as a smart phone, a laptop, a desktop, a rack-mounted computer, or a server (e.g., a server storing software distributed by downloading over a network, such as an app store)). As used herein, the term “computer-readable storage medium” encompasses only a non-transitory computer-readable medium that can be considered to be a manufacture (i.e., article of manufacture) or a machine. Alternatively, or additionally, aspects of the technology described herein may be embodied as a computer readable medium other than a computer-readable storage medium, such as a propagating signal.

The terms “program” or “software” are used herein in a generic sense to refer to any type of computer code or set of processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor, but may be distributed in a modular fashion among a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 1B, 2, 3A, and 3B. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Various aspects are described in this disclosure, which include, but are not limited to, the following aspects:
1. A system for time series forecasting using a pattern matching-based machine learning model, the system comprising: at least one computer hardware processor, and at least one non-transitory computer-readable storage medium storing processor-executable instructions that, when executed by the at least one computer hardware processor, causes the at least one computer hardware processor to perform a method comprising: obtaining a target time series, obtaining at least one reference time series associated with the target time series, generating a self-similarity vector for the reference time series by determining a similarity between a current time window of the reference time series and one or more subsequences of the reference time series, different from the current time window, based on the self-similarity vector, identifying one or more historic timestamps of the reference time series with similarity values above a threshold similarity value, generating one or more future projections of the target time series based on the identified timestamps, and generating a forecasting of the target time series using a read-out function.
2. The system of aspect 1, wherein the forecasting of the target time series comprises a forecasting of future timestamps of the target time series and a confidence score.
3. The system of any of aspects 1-2, wherein the forecasting of the target time series comprises a future distribution of the target time series.
4. The system of any of aspects 1-3, wherein at least one processor is further programmed to perform: determining whether a decision should be taken based on the forecasting of the target time series.
5. The system of any of aspects 1-4, wherein obtaining the at least one reference time series comprises: transforming the target time series into the at least one reference time series.
6. The system of any of aspects 1-5, wherein obtaining the at least one reference time series comprises obtaining the at least one reference time series from a data source external to the system, or obtaining the at least one reference time series from storage of the system.
7. The system of any of aspects 1-6, wherein the at least one reference time series comprises a plurality of reference time series, generating the self-similarity vector comprises generating a respective plurality of self-similarity vectors, and wherein the at least one computer hardware processor is further configured to perform: assigning respective weights to each of the plurality self-similarity vectors, and integrating the plurality of self-similarity vectors using an integration function, wherein the one or more historic timestamps are determined based on the integrated self-similarity vectors.
8. The system of any of aspects 1-7, wherein the at least one computer hardware processor is further configured to perform: training a machine learning model, wherein the training comprises: determining one or more historic time points from the target time series, and for each of the one or more historic time points: determining respective relevant time points from the target time series, based on a plurality of parameters, wherein each of the relevant time points occur earlier in the time series than the historic time point, comparing a portion of the target time series following the historic time point to a portion of the target time series following each of the relevant time points, and based on the comparing, updating one or more of the plurality of parameters.
9. The system of aspect 8, wherein the plurality of parameters comprises: a subsequence length for generating the self-similarity vector, self-similarity vector weights, and read-out function parameters.
10. The system of any of aspects 1-9, wherein generating the self-similarity vector comprises: for each of the one or more subsequences: determining a distance between the current time window and the subsequence and concatenating the distance into a self-similarity vector.
11. A method for time series forecasting using a pattern matching-based machine learning model, the method comprising: using at least one computer hardware processor to perform: obtaining a target time series, obtaining at least one reference time series associated with the target time series, generating a self-similarity vector for the reference time series by determining a similarity between a current time window of the reference time series and one or more subsequences of the reference time series, different from the current time window, based on the self-similarity vector, identifying one or more historic timestamps of the reference time series with similarity values above a threshold similarity value, generating one or more future projections of the target time series based on the identified timestamps, and generating a forecasting of the target time series using a read-out function.
12. The method of aspect 11, wherein obtaining the at least one reference time series comprises: transforming the target time series into the at least one reference time series, obtaining the at least one reference time series from a data source external to a system containing the at least one computer hardware processor, or obtaining the at least one reference time series from storage of the system.
13. The method of any of aspects 11-12, wherein the at least one reference time series comprises a plurality of reference time series, generating the self-similarity vector comprises generating a respective plurality of self-similarity vectors, and further comprising: assigning respective weights to each of the plurality self-similarity vectors, and integrating the plurality of self-similarity vectors using an integration function, wherein the one or more historic timestamps are determined based on the integrated self-similarity vectors.
14. The method of any of aspects 11-13, further comprising: training a machine learning model, wherein the training comprises: determining one or more historic time points from the target time series, and for each of the one or more historic time points: determining respective relevant time points from the target time series, based on a plurality of parameters, wherein each of the relevant time points occur earlier in the time series than the historic time point, comparing a portion of the target time series following the historic time point to a portion of the target time series following each of the relevant time points, and based on the comparing, updating one or more of the plurality of parameters.
15. The method of aspect 14, wherein the plurality of parameters comprises: a subsequence length for generating the self-similarity vector, self-similarity vector weights, and read-out function parameters.
16. The method of any of aspects 11-15, wherein generating the self-similarity vector comprises: for each of the one or more subsequences: determining a distance between the current time window and the subsequence, and concatenating the distance into a self-similarity vector.
17. At least one non-transitory computer-readable storage medium storing processor-executable instructions that, when executed by at least one computer hardware processor, causes the at least one computer hardware processor to perform a method comprising: obtaining a target time series, obtaining at least one reference time series associated with the target time series, generating a self-similarity vector for the reference time series by determining a similarity between a current time window of the reference time series and one or more subsequences of the reference time series, different from the current time window, based on the self-similarity vector, identifying one or more historic timestamps of the reference time series with similarity values above a threshold similarity value, generating one or more future projections of the target time series based on the identified timestamps, and generating a forecasting of the target time series using a read-out function.
18. The non-transitory computer-readable storage medium of aspect 17, wherein obtaining the at least one reference time series comprises: transforming the target time series into the at least one reference time series, obtaining the at least one reference time series from a data source external to a system containing the at least one computer hardware processor, or obtaining the at least one reference time series from storage of the system.
19. The non-transitory computer-readable storage medium of any of aspects 17-18, wherein the at least one reference time series comprises a plurality of reference time series, generating the self-similarity vector comprises generating a respective plurality of self-similarity vectors, and wherein the method further comprises: assigning respective weights to each of the plurality self-similarity vectors, and integrating the plurality of self-similarity vectors using an integration function, wherein the one or more historic timestamps are determined based on the integrated self-similarity vectors.
20. The non-transitory computer-readable storage medium of any of aspects 17-19, wherein the method further comprises: training a machine learning model, wherein the training comprises: determining one or more historic time points from the target time series, and for each of the one or more historic time points: determining respective relevant time points from the target time series, based on a plurality of parameters, wherein each of the relevant time points occur earlier in the time series than the historic time point, comparing a portion of the target time series following the historic time point to a portion of the target time series following each of the relevant time points, and based on the comparing, updating one or more of the plurality of parameters, wherein the plurality of parameters comprises: a subsequence length for generating the self-similarity vector, self-similarity vector weights, and read-out function parameters.

What is claimed is:

1. A system for time series forecasting using a pattern matching-based machine learning model, the system comprising:
at least one computer hardware processor; and
at least one non-transitory computer-readable storage medium storing processor-executable instructions that, when executed by the at least one computer hardware processor, causes the at least one computer hardware processor to perform a method comprising:
obtaining a target time series;
obtaining at least one reference time series associated with the target time series;
generating a self-similarity vector for the reference time series by determining a similarity between a current time window of the reference time series and one or more subsequences of the reference time series, different from the current time window;
based on the self-similarity vector, identifying one or more historic timestamps of the reference time series with similarity values above a threshold similarity value;
generating one or more future projections of the target time series based on the identified timestamps; and
generating a forecasting of the target time series using a read-out function.

2. The system of claim 1, wherein the forecasting of the target time series comprises a forecasting of future timestamps of the target time series and a confidence score.

3. The system of claim 1, wherein the forecasting of the target time series comprises a future distribution of the target time series.

4. The system of claim 1, wherein the at least one computer hardware processor is further caused to perform:
determining whether a decision should be taken based on the forecasting of the target time series.

5. The system of claim 1, wherein obtaining the at least one reference time series comprises:
transforming the target time series into the at least one reference time series.

6. The system of claim 1, wherein obtaining the at least one reference time series comprises obtaining the at least one reference time series from a data source external to the system, or obtaining the at least one reference time series from storage of the system.

7. The system of claim 1, wherein the at least one reference time series comprises a plurality of reference time series, generating the self-similarity vector comprises generating a respective plurality of self-similarity vectors, and wherein the at least one computer hardware processor is further configured to perform:
assigning respective weights to each of the plurality self-similarity vectors; and
integrating the plurality of self-similarity vectors using an integration function, wherein the one or more historic timestamps are determined based on the integrated self-similarity vectors.

8. The system of claim 1, wherein the at least one computer hardware processor is further configured to perform:
training a machine learning model, wherein the training comprises:
determining one or more historic time points from the target time series; and
for each of the one or more historic time points:
determining respective relevant time points from the target time series, based on a plurality of parameters, wherein each of the relevant time points occur earlier in the time series than the historic time point;
comparing a portion of the target time series following the historic time point to a portion of the target time series following each of the relevant time points; and
based on the comparing, updating one or more of the plurality of parameters.

9. The system of claim 8, wherein the plurality of parameters comprises: a subsequence length for generating the self-similarity vector, self-similarity vector weights, and read-out function parameters.

10. The system of claim 1, wherein generating the self-similarity vector comprises:
for each of the one or more subsequences:
determining a distance between the current time window and the subsequence; and
concatenating the distance into a self-similarity vector.

11. A method for time series forecasting using a pattern matching-based machine learning model, the method comprising:
using at least one computer hardware processor to perform:
obtaining a target time series;
obtaining at least one reference time series associated with the target time series;
generating a self-similarity vector for the reference time series by determining a similarity between a current time window of the reference time series and one or more subsequences of the reference time series, different from the current time window;
based on the self-similarity vector, identifying one or more historic timestamps of the reference time series with similarity values above a threshold similarity value;
generating one or more future projections of the target time series based on the identified timestamps; and
generating a forecasting of the target time series using a read-out function.

12. The method of claim 11, wherein obtaining the at least one reference time series comprises:
transforming the target time series into the at least one reference time series, obtaining the at least one reference time series from a data source external to a system containing the at least one computer hardware processor, or obtaining the at least one reference time series from storage of the system.

13. The method of claim 11, wherein the at least one reference time series comprises a plurality of reference time series, generating the self-similarity vector comprises generating a respective plurality of self-similarity vectors, and further comprising:
assigning respective weights to each of the plurality self-similarity vectors; and
integrating the plurality of self-similarity vectors using an integration function, wherein the one or more historic timestamps are determined based on the integrated self-similarity vectors.

14. The method of claim 11, further comprising:
training a machine learning model, wherein the training comprises:
determining one or more historic time points from the target time series; and
for each of the one or more historic time points:
determining respective relevant time points from the target time series, based on a plurality of parameters, wherein each of the relevant time points occur earlier in the time series than the historic time point;
comparing a portion of the target time series following the historic time point to a portion of the target time series following each of the relevant time points; and
based on the comparing, updating one or more of the plurality of parameters.

15. The method of claim 14, wherein the plurality of parameters comprises: a subsequence length for generating the self-similarity vector, self-similarity vector weights, and read-out function parameters.

16. The method of claim 11, wherein generating the self-similarity vector comprises:
for each of the one or more subsequences:
determining a distance between the current time window and the subsequence; and
concatenating the distance into a self-similarity vector.

17. At least one non-transitory computer-readable storage medium storing processor-executable instructions that, when executed by at least one computer hardware processor, causes the at least one computer hardware processor to perform a method comprising:
obtaining a target time series;
obtaining at least one reference time series associated with the target time series;
generating a self-similarity vector for the reference time series by determining a similarity between a current time window of the reference time series and one or more subsequences of the reference time series, different from the current time window;
based on the self-similarity vector, identifying one or more historic timestamps of the reference time series with similarity values above a threshold similarity value;
generating one or more future projections of the target time series based on the identified timestamps; and
generating a forecasting of the target time series using a read-out function.

18. The non-transitory computer-readable storage medium of claim 17, wherein obtaining the at least one reference time series comprises:
transforming the target time series into the at least one reference time series, obtaining the at least one reference time series from a data source external to a system containing the at least one computer hardware processor, or obtaining the at least one reference time series from storage of the system.

19. The non-transitory computer-readable storage medium of claim 17, wherein the at least one reference time series comprises a plurality of reference time series, generating the self-similarity vector comprises generating a respective plurality of self-similarity vectors, and wherein the method further comprises:
assigning respective weights to each of the plurality self-similarity vectors; and
integrating the plurality of self-similarity vectors using an integration function, wherein the one or more historic timestamps are determined based on the integrated self-similarity vectors.

20. The non-transitory computer-readable storage medium of claim 17, wherein the method further comprises:
training a machine learning model, wherein the training comprises:
determining one or more historic time points from the target time series; and
for each of the one or more historic time points:
determining respective relevant time points from the target time series, based on a plurality of parameters, wherein each of the relevant time points occur earlier in the time series than the historic time point;
comparing a portion of the target time series following the historic time point to a portion of the target time series following each of the relevant time points; and
based on the comparing, updating one or more of the plurality of parameters, wherein the plurality of parameters comprises: a subsequence length for generating the self-similarity vector, self-similarity vector weights, and read-out function parameters.
